(19) United States
(12) Patent Application Publication
(10) Pub. No.: US 2018/0282192 A1
(43) Pub. Date: Oct. 4, 2018

(54) METHOD AND APPARATUS FOR WATER TREATMENT

(71) Applicant: HYDRO INDUSTRIES LIMITED, LIanennech (GB)

(72) Inventors: Stephen Richard PERRY, Llangennech (GB); Michael Luis GERARDO, Llangennech (GB)

(21) Appl. No.: 15/566,544

(22) PCT Filed: Apr. 7, 2016
(86) PCT No.: PCT/GB2016/050968

§ 371 Date: Oct. 13, 2017

(30) Foreign Application Priority Data
Apr. 15, 2015 (GB) 1506358.9

(51) Int. Cl. C02F 9/00

(52) U.S. Cl. CPC C02F 9/00; C02F 1/004

(57) ABSTRACT

The invention concerns a method and apparatus for water treatment. More particularly, the invention concerns a method and apparatus for water treatment using electro coagulation. A portable water treatment apparatus comprises a water inlet, a water retention tank, an electrode cartridge, and a water outlet. The water inlet is in fluid communication with the water retention tank. The water treatment apparatus is arranged to circulate water from the retention tank, through the electrode cartridge, and back into the retention tank.

### FIELD OF THE INVENTION

The present invention concerns a method and apparatus for water treatment. More particularly, but not exclusively, this invention concerns a method and apparatus for water treatment using electrocoagulation.

### BACKGROUND OF THE INVENTION

The treatment of industrial effluents, process waters, river and pond water, streams, groundwater, and other fluids is often required in order to eliminate chemical and biological contaminants. The decontamination may be to reduce contaminant levels, for example water containing any dissolved and non-dissolved substances such as biological matter, suspended and colloidal materials, inorganic and organic materials, organo-metallic compounds, and radioactive materials, to the limits defined in various discharge or drinking water regulations. The need for water treatment is often greatest in areas with relatively little infrastructure, such as remote areas, and on army or humanitarian missions. Alternatively the need may be in areas of high urban density, but with little room for traditional water treatment plants.

Typical water treatment methods include biological treatment, coagulation by adding inorganic salts of organic polymers, flotation, sedimentation, filtration, and aeration. Physical treatment is typically achieved by exploiting physical properties such as size and density during filtration, sedimentation, or flotation, of the undesired contaminants. Biological treatment is applied when the contaminants consist of a bio-degradable nature, and includes maintaining biological organisms to which the contaminated water is fed. Chemical treatments include chemical additions to water which promote the coagulation and separation of the unwanted contaminants. Such practice has been found to be deleterious to water quality, increase operational costs, and the amount of sludge being produced. The chemicals require rigorous control on dosing and handling to minimise the environmental impact. Additionally, typical methods rely on treatment of large volumes of water at centralised water treatment plants. Lack of space and/or infrastructure mean that such centralised water treatment plants are not always possible.

Electrocoagulation is another possible water treatment method. Decontamination of fluids using electrolysis has been carried out in tanks and elongate tubular apparatus. Electrodes are usually attached to the fluid holding vessel and suspended in the medium, or enclosed between non-conducting surfaces through which the contaminated water flows. Example devices include the iron flat plate electrodes and CO₂ mixing and floatation described in U.S. Pat. No. 6,878,268. Other prior art examples include US2009/0107915, US2013/0075333, EP2767513, US2010/0084272, IN216,241, and GB2424875. However, all of these prior art apparatus include electrode configurations which require large footprint areas, slower reaction times, and mechanical mixing. They are also prone to fouling, clogging, and passivation, which substantially reduces performance, and increases maintenance time. The electrode configuration may also prove difficult for handling purposes.

The present invention seeks to mitigate the above-mentioned problems. Alternatively or additionally, the present invention seeks to provide an improved method and apparatus for water treatment.

### SUMMARY OF THE INVENTION

The present invention provides, according to a first aspect, a portable water treatment apparatus comprising: a water inlet, a water retention tank, an electrode cartridge, and a water outlet, wherein the water inlet is in fluid communication with the water retention tank, the water treatment apparatus being arranged to circulate water from the retention tank, through the electrode cartridge, and back into the retention tank. The water outlet is arranged to allow the egress of water from the water treatment apparatus. The water inlet is arranged for the ingress of water to the water treatment apparatus.

The portable treatment apparatus may comprise a recirculation pump associated with the water retention tank, the recirculation pump arranged to pump water from the retention tank through the electrode cartridge, and back into the retention tank. Recirculation of water from the retention tank, through the electrode cartridge, increases the contact time the water has in the electrode cartridge, without requiring further electrode tubes to be provided. Therefore, a space saving may be made compared to prior art water treatment apparatus, which may require a number of electrode cartridges, or a larger single electrode cartridge, to treat the same volume of water.

The portable water treatment apparatus may comprise an inlet pump associated with the water inlet. The recirculation pump may have a greater flow rate than the inlet pump. Such an arrangement may ensure that water in the water retention tank is recirculated through the electrode cartridge at a faster rate than water is pumped from the water inlet into the water retention tank.

The portable water treatment apparatus may comprise a housing, the housing containing the retention tank and the electrode cartridge. The housing may be associated with one or more lifting devices. The lifting devices may comprise lifting eyes attached to the housing. Such lifting devices may allow the portable water treatment apparatus to be lifted by a crane or similar lifting apparatus. The lifting devices may comprise one or more lifting channels. The lifting devices may allow the portable water treatment apparatus to be lifted by a forklift truck or similar lifting apparatus. The portable water treatment apparatus may be sized for transportation by a van or small truck. The portable water treatment apparatus may have an approximately square or rectangular footprint, with a size of between 1 m and 2.5 m in width, for example with a footprint of 1.5 m×1.5 m. The portable water treatment apparatus may be between 1 m and 3 m high, for example approximately 1.8 m high. The weight of the water treatment apparatus may fall within a range of 300 kg to 1000 kg, for example, 650 kg. Such a water treatment apparatus may be easily transported to areas of need, and also received in areas with small available footprint. Therefore, a transportable and localised water treatment apparatus is provided.

The portable water treatment apparatus may comprise a screening filter, the screening filter placed in the fluid flow path between the water inlet and the retention tank. The screening filter may reduce the amount of large particulate matter entering the water retention tank.

The portable water treatment apparatus may comprise a chemical adsorption unit.

The portable water treatment apparatus may comprise a filtration unit. The portable water treatment apparatus may comprise a depth filter unit. The portable water treatment apparatus may comprise a microfilter unit, a nanofilter unit, and/or a reverse osmosis unit.

The portable water treatment apparatus may comprise a deionisation unit, for example using reverse osmosis or ion exchange resin. Such a unit may reduce water hardness, total dissolved solids, conductivity, and other palatable dissolved contaminants.

The portable water treatment apparatus may comprise a sterilization unit.

The portable water treatment apparatus may comprise a UV treatment unit.

The portable water treatment apparatus may comprise a disinfection unit.

The water inlet of the portable water treatment apparatus may be fed by the output of a sedimentation tank, particularly in the case of treatment of waste water fluids.

The portable water treatment apparatus may provide an apparatus for the decentralised treatment and supply of drinking water.

The invention provides, according to a second aspect, an electrode cartridge for use in an electrocoagulation process, the electrode cartridge comprising concentric tubular electrodes comprising a first, inner, electrode, and a second, outer, electrode, a cathode connector extending between the antipodal sides of one of the first electrode and second electrode, and an anode connector extending between the antipodal sides of the other of the first electrode and second electrode.

The electrode cartridge may comprise an inlet, to allow the ingress of fluid to be treated by electrocoagulation, and an outlet, for the egress of fluid that has passed through the electrode cartridge.

The electrode cartridge may comprise a first connecting stud attached to the cathode connector. The first connecting stud may be removably attached to the cathode connector. The electrode cartridge may comprise a second connecting stud attached to the anode connector. The second connecting stud may be removably attached to the anode connector. The connecting studs may be removably attached to the cathode and anode connectors by a screw fitting.

The electrode cartridge may comprise an insulating outer shell. The first and second connecting studs may extend through the insulating outer shell, attaching to the cathode and anode connectors, and providing a connection point on the outside of the insulating outer shell. One or more seal rings may be associated with the connecting studs to ensure the connection through the insulating outer shell is watertight.

The electrode cartridge may comprise one or more insulating support rods extending between the first electrode and second electrode. The support rods may keep the spacing between the first and second electrodes constant along their length. The support rods may increase turbulence as fluid flows through the electrode cartridge.

The electrode cartridge may comprise a third tubular electrode, the third tubular electrode located between the first electrode and second electrode. The support rods may act to keep the spacing between the first, second, and third electrode tubes consistent along their length. The electrode cartridge may comprise between four and six concentric electrodes, the additional electrodes located between the first electrode and second electrode. Support rods may extend between all of the electrodes to maintain a constant separation between the electrodes. The support rods may also increase the turbulent flow of a fluid passing through the electrode cartridge, thereby increasing the contact time the fluid has with the electrodes.

Increasing the turbulent flow between the electrodes may minimise the development of a passivation layer and fouling on the electrodes. This may reduce the need to maintain the electrode cartridge during use, and increase the potential volume of fluid which may be processed by the electrode cartridge.

The electrode cartridge be may comprise a stop, the stop associated with an end of the first, inner, electrode. The stop may be arranged to prevent fluid flow through the inner part of the first electrode. The stop may comprise a shaped end, the shaped end configured to improve fluid flow around the end. The shaped end may be pointed, for example, the shaped end may be conical.

The invention provides, according to a third aspect, a method of treating water, the method comprising the steps of: providing a portable water treatment apparatus as described with reference to the first aspect of the invention, feeding water into the water retention tank via the water inlet, circulating and recirculating water from the water retention tank through the electrode cartridge, and expelling water that has been treated from the water treatment apparatus.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a flow diagram of a water treatment method according to a first embodiment of the invention;

FIG. 2 shows an outer perspective view of a water treatment apparatus according to a second embodiment of the invention;

FIG. 3 shows a partially exploded view of the water treatment apparatus according to the second embodiment of the invention;

FIG. 4 shows a front-side perspective view of the inside of a water treatment apparatus according to the second embodiment of the invention;

FIG. 5 shows a rear-side view of a water treatment apparatus according to the second embodiment of the invention;

FIG. 6 shows a plan view of a water treatment apparatus according to the second embodiment of the invention;

FIG. 7 shows a fragmentary view of an electrode cartridge according to a third embodiment of the invention;

FIG. 8 shows an end to end cross section of an electrode cartridge according to a third embodiment of the invention;

FIG. 9 shows a plan view of the inlet of the of an electrode cartridge according to a third embodiment of the invention; and

FIG. 10 shows a bottom view of the outlet of an electrode cartridge according to a third embodiment of the invention.

### DETAILED DESCRIPTION

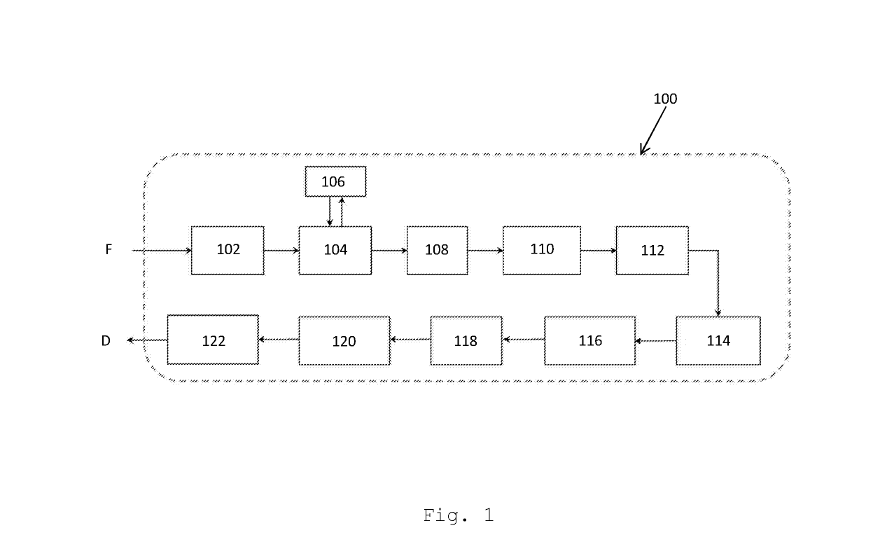

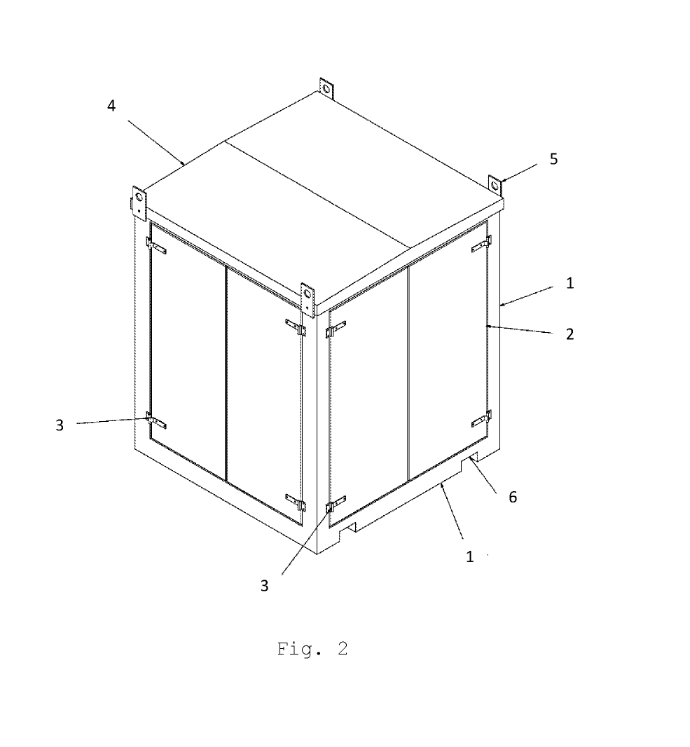

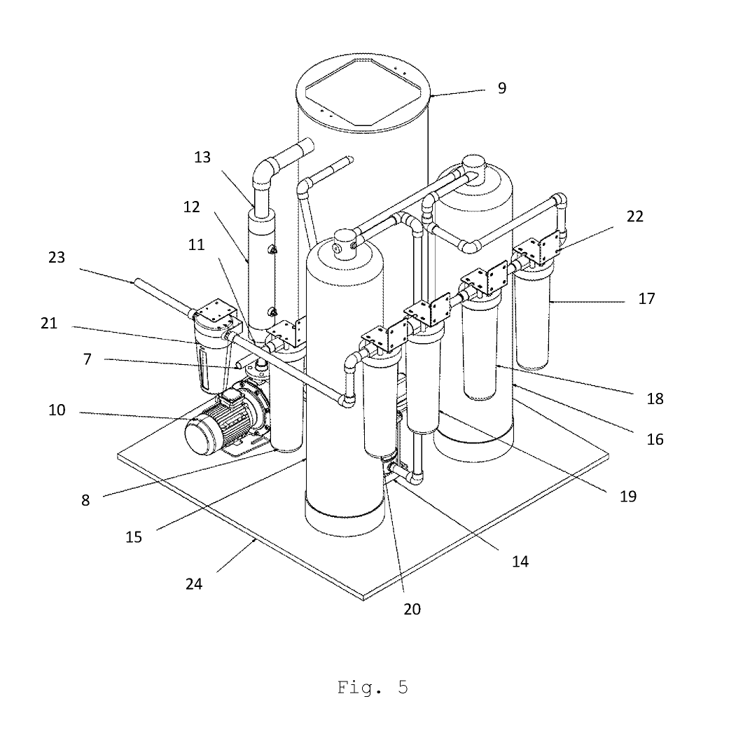

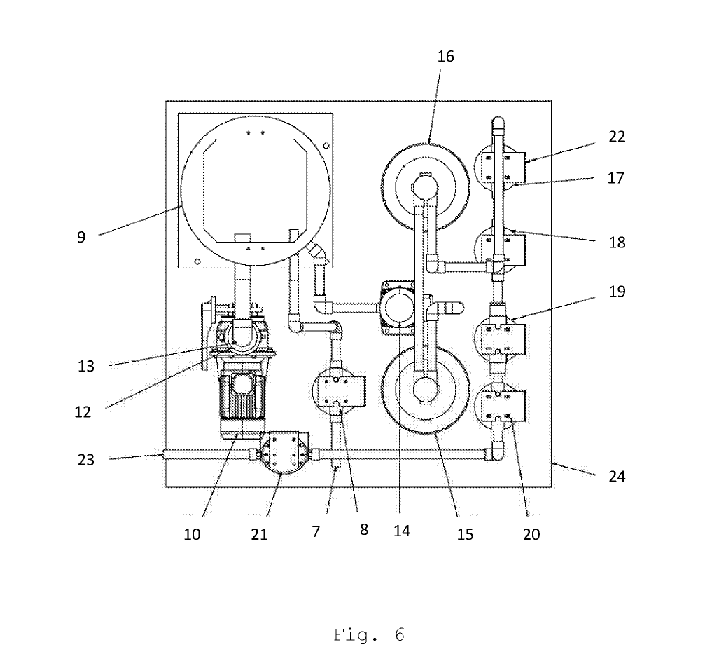

FIG. 1 shows a flow chart of a method of treating water according to a first embodiment of the invention. The method steps are surrounded by a dashed box 100, indicating each of the method steps within the box 100 take place within a containerised water treatment apparatus as described with reference to FIGS. 2 to 6. The method of water treatment includes feed water being taken in by a water inlet, and passed through a screening unit 102, to remove any large particulate matter in the feed water. From the screening unit 102, the water is passed into a retention tank 104. The water within the retention tank 104 is circulated, and recirculated through at least one electrode cell 106. Water is also pumped from the retention tank 104 into a depth filter unit 108, from the depth filter unit 108 into the chemical adsorption unit 110, from the chemical adsorption unit 110 into the filtration unit 112, from the filtration unit 112 into the sterilisation unit 114, from the sterilisation unit 114 into the microfilter unit 116, from the microfilter unit 116 into the UV unit 118, from the UV unit 118 into the microfilter unit 120, from the microfilter unit 120 into the disinfection unit 112, and from the disinfection unit 122 clean drinking water is sent out from an outlet of the containerised water treatment apparatus 100.

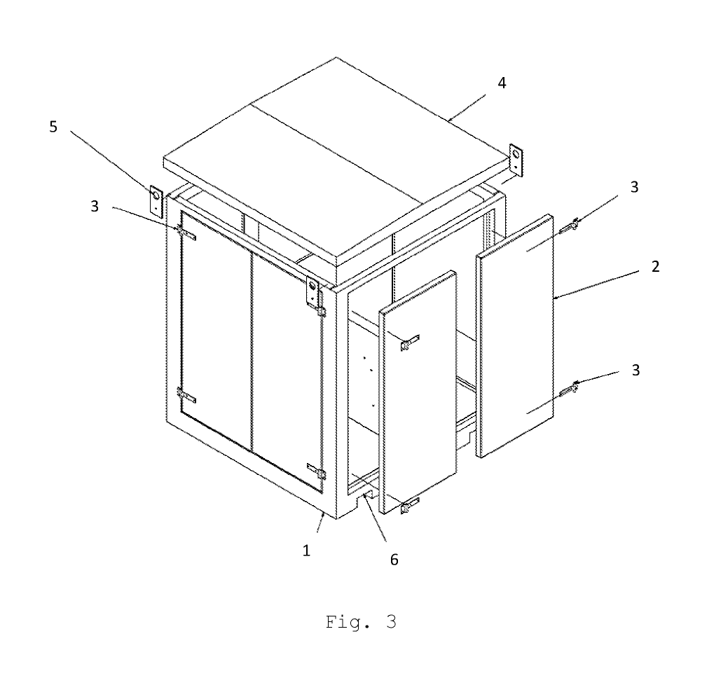

FIGS. 2 and 3 show a water treatment apparatus comprising an outer container within which the various water treatment units are housed. The container comprises a rectangular frame 1, with hinged side panels 2. Each side panel includes a top and bottom hinge 3, which allows the doors to be opened to access the inside of the container. A top lid 4 is also provided, with four lifting eyes 5 provided at the corners of the rectangular frame 1. At the base of the rectangular frame, there are two lifting channels 6, which allow the container to be lifted by a forklift truck.

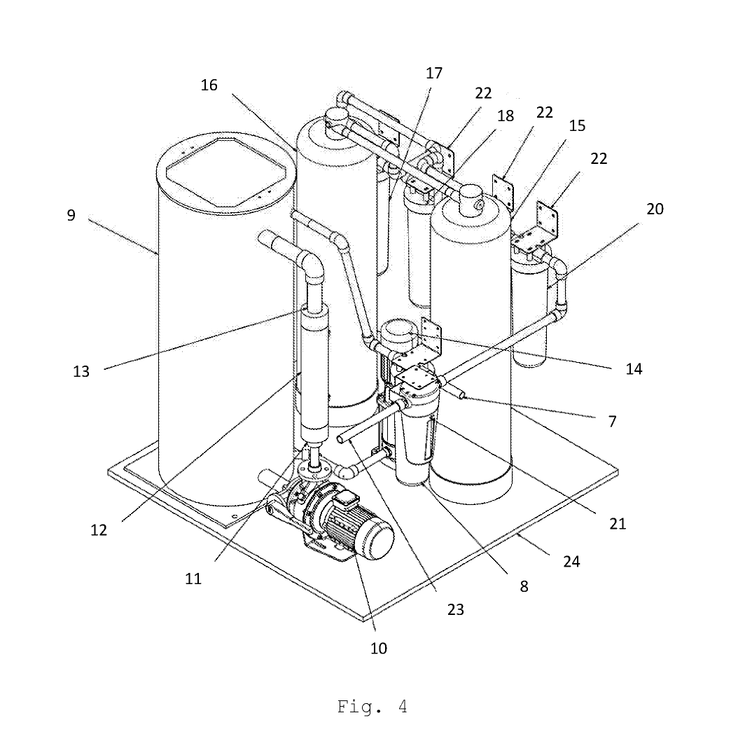

FIGS. 4, 5, and 6, show the inside of the water treatment apparatus, with the rectangular frame 1, side panels 3, and lid 4 removed. A feed pump (not shown) connected to an inlet pipe 7 provides an appropriate flow of feed water into the water treatment apparatus. The inlet pipe 7 feeds into a screening unit 8 which removes large particulate matter from the water. The screened liquid then enters a retention tank 9 at the top of the tank. A pump 10 circulates and recirculates the liquid through an electrode cartridge 12 via an inlet 11. Tubing 13 at the top of the electrode cartridge 12 returns the fluid to the retention tank 9. Whilst only a single electrode cartridge 12 is shown, the skilled person will appreciated that a number of electrode cartridges may be used. Various filters, 15, 16, 17, 18, and 20, are fixed within the water treatment apparatus, and water being treated is circulated through these filters. Sterilisation units 19 and 21 are also arranged such that the water being treated is circulated through these units. Brackets 22 help to secure the various water treatment units and connecting pipes within the container of the water treatment apparatus. The water treatment apparatus also comprises a control unit (not shown) which is configured to receive a source of single phase AC power between 220 and 240 volts, and transform this into a DC supply with a maximum of 180 volts and 16 amps. This supply is connected to the electrode cartridge 12. The control unit also controls the operation of the various pumps within the water treatment apparatus, and also the operation of a number of valves which control the flow of water/fluid through the water treatment apparatus. The control unit may also comprise a user interface to enable a user of the water treatment apparatus to control the water treatment process.

The operation of the water treatment apparatus is controlled such that the water is held within the retention tank 9 for the optimal reaction time, so that soluble and insoluble contaminants are coagulated. Optionally, an impeller and/or mixer are associated with the retention tank 9. The retention tank 9 may also include a chemical additive supply, whereby chemicals such as salt, acid, or alkali, are added to the water within the retention tank 9 in a controlled manner. To reduce the accumulation of bubbles, the retention tank 9 is kept open to the atmosphere.

The electrode cartridge 12 is fitted inline between the inlet pipe 11 and outlet pipe 13, using clamps with inner profile seals which provide a simple way of removing or replacing the electrode cartridge 12.

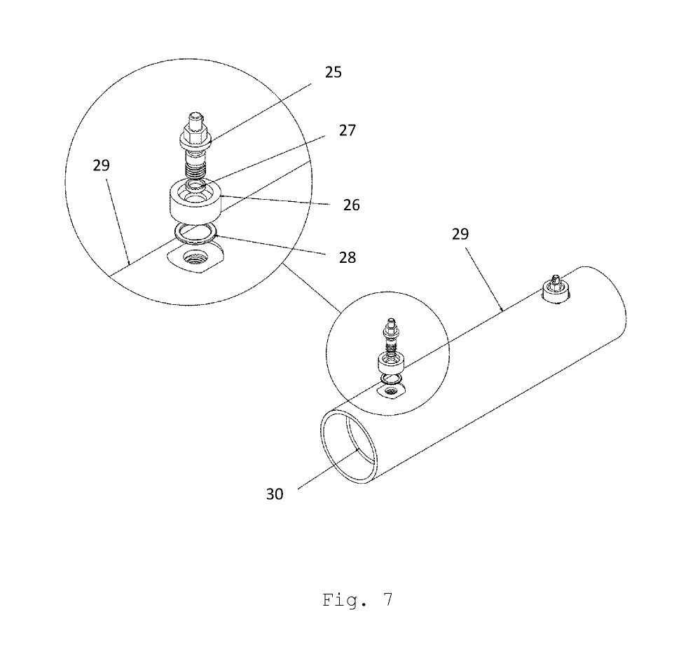

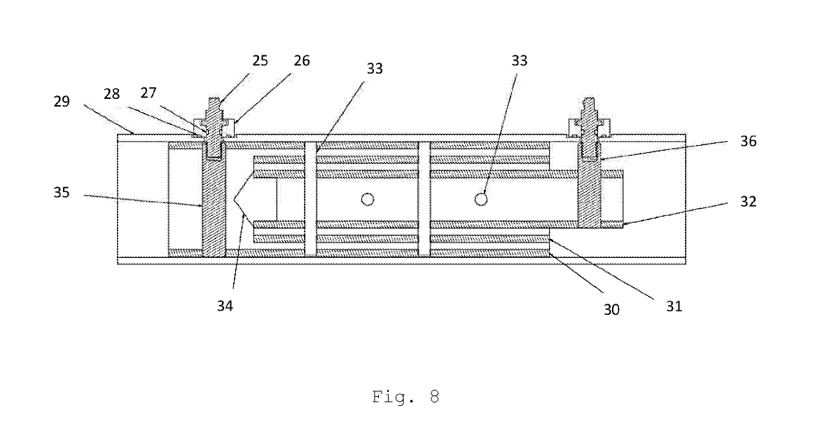

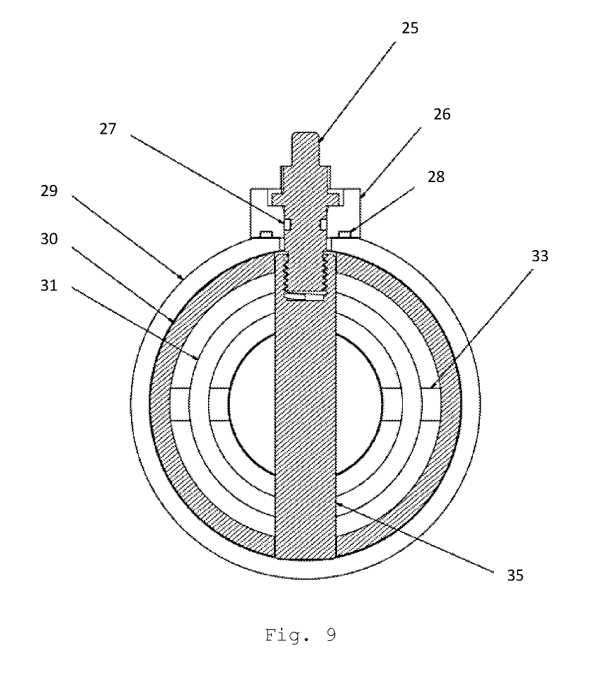

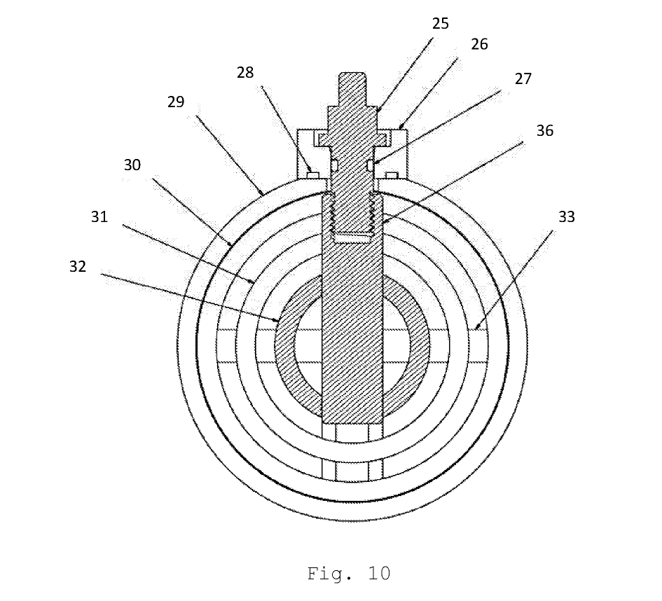

FIGS. 7 to 10 show an electrode cartridge 12 according to a third embodiment of the invention. The electrode cartridge 12 comprises connecting studs 25, mounting bushes 26 associated with each connecting stud, along with rubber seal rings 27 and 28. The connecting stud 25 is a male threaded stud, made of solid metal. The electrode cartridge 12 further comprises an outer surface 29, into which the connecting stud 25 is placed. The rubber seal rings 27 and 28, and the mounting bush 26, are non-conductive.

The electrode cartridge 12 comprises a plurality of concentric metal tubes 30, 31, and 32, which are separated equidistantly by a plurality of insulating supporting rods 33. The concentric metal tubes 30, 31, and 32, may be made of any conductive material appropriate for electrolytic coagulation of contaminants in water, for example, aluminium, iron, silver, manganese, magnesium, gold, rubidium, platinum or carbon. The support rods 33 space the concentric metal tubes 30, 31, and 32, preventing any short circuiting of the electrode cartridge 12. The support rods 33 also act to increase the turbulence of the flow of any water through the electrode cartridge 12. This increases the frequency of collisions between the contaminants and the media, superficial velocity of the flow, liquid shear, and also reduces the fouling of the electrodes.

The electrode cartridge may comprise between two and five concentric tubes, with a length of between 100 and 2000 mm, and a diameter ranging from 20 mm to 500 mm. The thickness of the concentric metal tubes and the gap between the tubes, may be between 2 mm to 100 mm. Given how the tubes are connected, only the innermost and outermost tubes, 32, 30 are directly charged. The intermediate tubes 31 are charged by electromagnetic induction. This provides a system with lower power requirements, and with a lower gas build up. A blocking cap 34 is provided which stops contaminated water from reaching the inside of the inner electrode 30. The blocking cap 34 is made of a non-conductive material with a conical profile facing the flow of water, to reduce the build-up of any contaminants on the blocking cap 34, and/or restriction of the flow of water through the electrode cartridge 12. The water flows through the caps between the concentric tubes 30, 31, 32, and is directed back into the reaction tank 9.

The electrode cartridge 12 also comprises a cathode connector 35 and anode connector 36. Both the cathode connector 35 and anode connector 36 are welded perpendicular to the longitudinal axes of the tubes 30, 31, 32. In alternative embodiments of the invention, alternative fixing methods may be used as will be appreciated by the skilled person. Each connector 35, 36, is made of a solid metal, and include a tap hole with a female thread into which a connecting stud 25 may be screwed. The cathode connector 35 extends between antipodal sides of the cathode 30, and provides an efficient charge distribution across the length of the cathode 30, substantially increasing the efficiency of the water treatment process. The anode connector 36 extends between the antipodal sides of the anode 32, and also provides an efficient charge distribution across the length of the anode 32. The connecting studs 25 and connectors 35, 36, may be connected using different connecting means, for example bayonet pin and twist fittings.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

The outer container of the water treatment apparatus may be of any suitable shape, for example, with a cross section which is circular, elliptical, oblong, triangular, or hexagonal. The outer container of the water treatment apparatus may comprise one or more access doors or hatches, for example to allow easy access to the internals of the water treatment apparatus for maintenance. The water treatment apparatus may be arranged such that air may be circulated around the inside of the outer container. The water treatment apparatus may comprise heating and/or cooling devices, to allow the temperature of the water treatment apparatus to be controlled. The water treatment apparatus may comprise devices for additional water treatment steps, including but not limited to, flotation, sedimentation, clarification, chemical treatment, or oxidation processes.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A portable water treatment apparatus comprising: a water inlet, a water retention tank, an electrode cartridge, and a water outlet, wherein the water inlet is in fluid communication with the water retention tank, the water treatment apparatus being arranged to circulate water from the retention tank, through the electrode cartridge, and back into the retention tank.

2. A portable water treatment apparatus as claimed in claim 1, comprising a recirculation pump associated with the water retention tank, the recirculation pump arranged to pump water from the retention tank through the electrode cartridge, and back into the retention tank.

3. A portable water treatment apparatus as claimed in claim 2, comprising an inlet pump associated with the water inlet.

4. A portable water treatment apparatus as claimed in claim 3, wherein the recirculation pump has a greater flow rate than the inlet pump.

5. A portable water treatment apparatus as claimed in claim 1, comprising a housing, the housing containing the retention tank and the electrode cartridge.

6. A portable water treatment apparatus as claimed in claim 5, wherein the housing is associated with one or more lifting devices.

7. A portable water treatment apparatus as claimed in claim 6, the lifting devices comprising lifting eyes attached to the housing.

8. A portable water treatment apparatus as claimed in claim 6, the lifting devices comprising one or more lifting channels.

9. A portable water treatment apparatus as claimed in claim 1, the portable water treatment apparatus sized for transportation by a van or small truck.

10. A portable water treatment apparatus as claimed in claim 1 comprising a screening filter, the screening filter placed in the fluid flow path between the water inlet and the retention tank.

11. A portable water treatment apparatus as claimed in claim 1, comprising a chemical adsorption unit.

12. A portable water treatment apparatus as claimed in claim 1, comprising a filtration unit.

13. A portable water treatment apparatus as claimed in claim 1, comprising a depth filter unit.

14. A portable water treatment apparatus as claimed in claim 1, comprising a microfilter unit, a nanofilter unit, and/or a reverse osmosis unit.

15. A portable water treatment apparatus as claimed in claim 1, comprising a deionisation unit.

16. A portable water treatment apparatus as claimed in claim 1, comprising a sterilization unit.

17. A portable water treatment apparatus as claimed in claim 1, comprising a UV treatment unit.

18. A portable water treatment apparatus as claimed in claim 1, comprising a disinfection unit.

19. A portable water treatment apparatus as claimed in claim 1, wherein the water inlet of the portable water treatment apparatus is in fluid communication with an output of a sedimentation tank.

20. An electrode cartridge for use in an electrocoagulation process, the electrode cartridge comprising concentric tubular electrodes comprising a first, inner, electrode, and a second, outer, electrode, a cathode connector extending between the antipodal sides of one of the first electrode and second electrode, and an anode connector extending between the antipodal sides of the other of the first electrode and second electrode.

21. An electrode cartridge as claimed in claim 20, comprising an inlet, to allow the ingress of fluid to be treated by electrocoagulation, and an outlet, for the egress of fluid that has passed through the electrode cartridge.

22. An electrode cartridge as claimed in claim 20, comprising a first connecting stud attached to the cathode connector.

23. An electrode cartridge as claimed in claim 22, wherein the first connecting stud is removably attached to the cathode connector.

24. An electrode cartridge as claimed in claim 22, comprising a second connecting stud attached to the anode connector.

25. An electrode cartridge as claimed in claim 24, wherein the second connecting stud is removably attached to the anode connector.

26. An electrode cartridge as claimed in claim 23, wherein the connecting stud is removably attached to the cathode or anode connector by a screw fitting.

27. An electrode cartridge as claimed in claim 24, comprising an insulating outer shell.

28. An electrode cartridge as claimed in claim 27, wherein the first and/or second connecting studs extend through the insulating outer shell, attaching to the cathode or anode connectors, and provide an electrical connection point on the outside of the insulating outer shell.

29. An electrode cartridge as claimed in claim 20, comprising one or more insulating support rods extending between the first electrode and second electrode.

30. An electrode cartridge as claimed in claim 20, comprising a third tubular electrode, the third tubular electrode located between the first electrode and second electrode.

31. An electrode cartridge as claimed in claim 30, comprising between four and six concentric electrodes, the additional electrodes located between the first electrode and second electrode.

32. An electrode cartridge as claimed in claim 20, comprising a stop, the stop associated with an end of the first, inner, electrode.

33. An electrode cartridge as claimed in claim 32, the stop arranged to prevent fluid flow through the inner part of the first electrode.

34. An electrode cartridge as claimed in claim 32, the stop comprising a shaped end, the shaped end configured to improve fluid flow around the end.

35. A method of treating water, the method comprising the steps of: providing a portable water treatment apparatus as described with reference to an apparatus of claim 1, feeding water into the water retention tank via the water inlet, circulating and recirculating water from the water retention tank through the electrode cartridge, and expelling water that has been treated from the water treatment apparatus.

36. (canceled)

37. (canceled)
